(19) United States
(12) Patent Application Publication
(10) Pub. No.: US 2014/0090713 A1
(43) Pub. Date: Apr. 3, 2014

(54) Vented Ball Valve

(71) Applicant: GEM PRODUCTS, INC., Orange Park, FL (US)

(72) Inventors: Jason Sarnowski, Jacksonville, FL (US); Erle Matthew Bridgewater, St. Johns, FL (US)

(73) Assignee: GEM PRODUCTS, INC., Orange Park, FL (US)

(21) Appl. No.: 13/631,008

(22) Filed: Sep. 28, 2012

(51) Int. Cl. F16K 5/06

(52) U.S. Cl. 137/1; 251/315.01

(57) ABSTRACT

A ball valve is disclosed having a pipe with two openings. The ball valve selectively permits the passage of liquids or gasses through the two openings. The ball of the ball valve includes a vent hole that communicates with only one of the openings when the ball valve is in the closed position to allow gases or liquids trapped inside the ball to escape the ball rather than expand and damage the ball.

### TECHNICAL FIELD OF THE INVENTION

The present application relates to a valve. Particularly, the present application relates to a ball valve with a vent structure that relieves pressure from the ball when the valve is in the closed position.

### BACKGROUND OF THE INVENTION

Ball valves are a common and well known means of selectively permitting the passage of gas or fluid. A typical ball valve includes a pipe with a ball located inside, the ball having a bore that communicates with the openings in the pipe when in the open position. The ball can be rotated into the open or closed position by a handle operable by a user. Before the ball is rotated, the bore aligns with the pipe and gas or fluid may pass through the pipe and ball. After the ball is rotated, the bore is blocked by the interior walls of the pipe and the remainder of the ball blocks gas or fluid from passing through either end of the pipe.

In the closed position, ball valves retain gas or fluid within the ball itself. The gas or fluid is trapped within the ball because the only opening in the ball, i.e., the bore, is blocked by the interior walls of the pipe. This can be especially problematic for ball valves used on boats that may encounter cold temperatures. Water can enter the ball during the day, when the ball valve is closed and when temperatures are warm. At night, however, temperatures can drop and the water trapped inside the ball can freeze and crack the interior of the ball.

Vented ball valves have been used to relieve pressure from components downstream from the valve. For example, U.S. Pat. No. 5,360,036 (the '036 Patent) discloses a ball valve having a pipe with first and second ends, as with a conventional ball valve. However, the ball valve of the '036 Patent also includes a third opening in the pipe that communicates with atmosphere, and a vent hole in the ball that communicates the third opening with a passage downstream of the ball valve. As a result, vapors downstream of the ball valve can travel through the vent hole in the ball, and through the third opening of the pipe, to be relieved into atmosphere. The '036 Patent ball valve therefore relieves pressure from vapors downstream from the ball rather than relieving vapors inside the ball itself Such a configuration requires a passage communicating with atmosphere, where such a passage may not be practical or convenient. Also, such a configuration ignores that gas or liquid may be trapped inside the ball itself, and instead focuses on pressure downstream of the valve.

### SUMMARY OF THE INVENTION

The present application discloses a ball valve having a first end and a second end, where the ball selectively permits the passage of air or fluid through the first and second ends. The ball includes a vent hole that communicates with only one of the first and second ends in the closed configuration to allow gas or fluid trapped inside the ball to escape rather than expand and damage the ball.

In particular, the present application discloses a ball valve including a pipe having first and second ends, a ball movably disposed within the pipe and adapted to selectively permit passage of gas or fluid through the first and second ends, the ball having a bore defined therein adapted to communicate with the first and second ends when the ball is disposed in an open position, and having a vent hole adapted to communicate with only the first end when the ball is disposed in the closed position.

Also disclosed is a method of resisting pressure buildup in a ball disposed within a ball valve, the method including providing the ball valve having a pipe with first and second ends and a ball movably disposed within the pipe, the ball having a bore defined therein adapted to communicate with the first and second ends when in an open position, and further having a vent hole adapted to communicate with only the first end when in a closed position, and moving the ball from the open position to the closed position, and allowing gas or fluid inside the ball to escape the ball through the vent hole and through the first end, wherein interior structure of the pipe resists the gas or fluid from escaping from any opening other than the vent hole and the first end.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of one embodiment of a ball valve in the closed position.

FIG. 2 is a front view of one embodiment of a ball valve in the open position.

FIG. 3 is a side sectional view of one embodiment of a ball valve in the closed position.

FIG. 4 is a front view of one embodiment of a ball valve in the closed position; and

FIG. 5 is a flow chart disclosing a process according to one embodiment of the present application.

It should be understood that the comments included in the notes as well as the materials, dimensions and tolerances discussed therein are simply proposals such that one skilled in the art would be able to modify the proposals within the scope of the present application.

### DETAILED DESCRIPTION OF THE EMBODIMENTS

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated.

The present application discloses a ball valve with a pipe having two openings. The ball valve selectively permits the passage of liquids or gasses through the two openings. The ball of the ball valve includes a vent hole that communicates with only one of the openings when the ball valve is in the closed position to allow gases or liquids trapped inside the ball to escape the ball rather than expand and damage the ball.

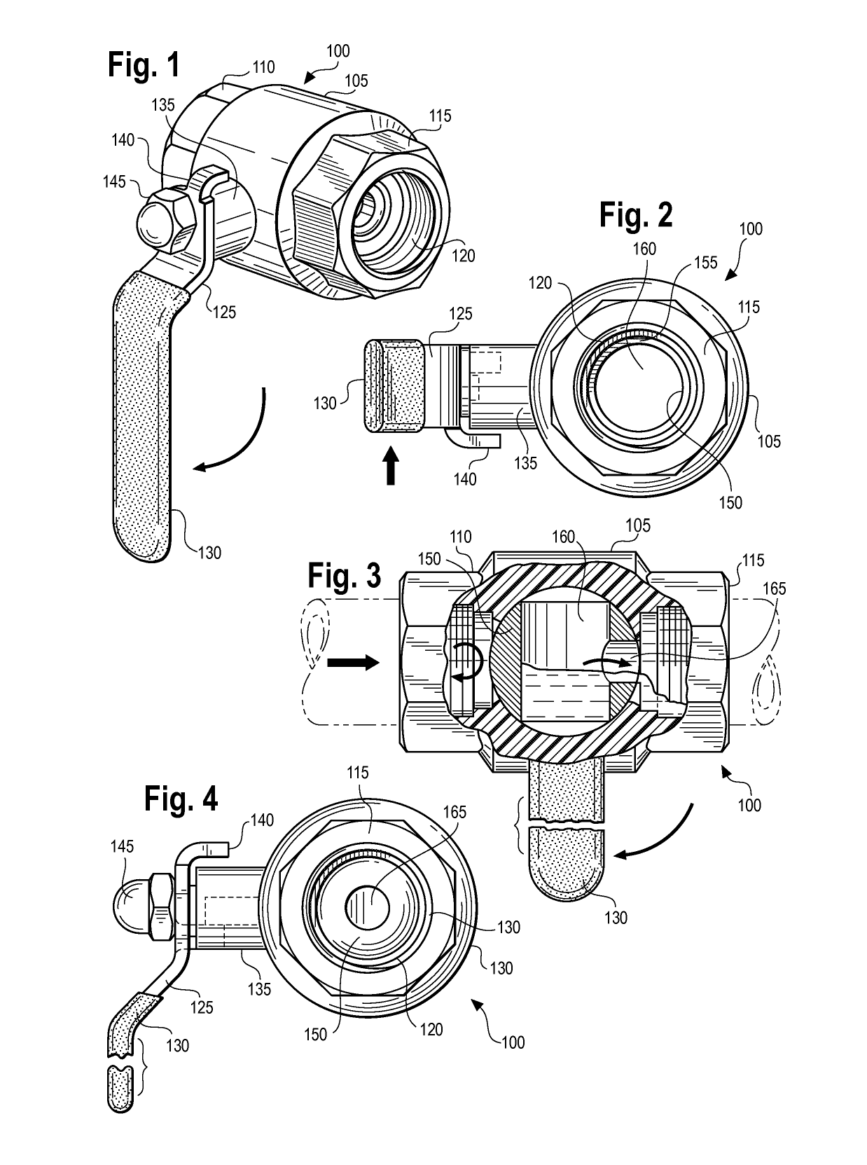

FIG. 1 shows a ball valve 100 according to an embodiment of the present application. As shown in FIG. 1, the ball valve is in the closed position where gas or fluid is not permitted to travel through the ball valve. The ball valve includes a pipe 105 having a first end 110 and a second end 115 opposite the first end 110. The first end 110 can be the inlet end of the pipe 105, where the second end 115 can be the outlet end of the pipe 105 downstream from the inlet end 110. However, the first end 110 and second 115 ends are not limited to being the inlet and outlet ends, but rather the first end 110 can be the outlet end and the second end 115 can be the inlet end, if desired.

The first end 110 and the second end 115 can include threads that couple the pipe to other components upstream or downstream from the ball valve 100. For example, the ball valve 100 can be coupled to a live well for storing fish or other marine animals and can selectively permit the flow of water to the live well.

The ball valve 100 can be operated in either the open position, permitting the flow of gas or fluid, or can be operated in a closed position, where gas or fluid is prevented from passing through the ball valve 100. To select either the open or closed positions, a handle 125 is provided with a grip 130 that the user can hold when actuating the handle 125 and selecting either the open or closed position for the ball valve 100. The handle 125 is coupled to an extension 135 of the pipe 105, and further includes a stop 140 that can abut against a portion of the extension 135 when rotated to the open or closed position. The handle 125 can be coupled to the extension 135 by a fastener 145, as shown in FIG. 1.

FIG. 2 discloses a front view of one embodiment of ball valve 100 in the open position. As shown, the handle 125 is rotated to be aligned with the axial direction of the pipe 105, but any orientation of the handle 125 relative to the pipe 105 can be implemented in either the open or closed position without departing from the spirit and scope of the present application.

As shown in FIGS. 2 and 3, the ball valve 100 can include a ball 150 surrounded by a valve seal 155 to seal gas or fluid when the ball valve 100 is in the closed position. The ball 150 can include a bore 160 that communicates with the first 110 and second 115 ends to allow the passage of gas or fluid when the ball valve 100 is in the open position. The ball 150 can also include a vent 165 that allows gas or fluid inside the ball 150 to escape from either the first end 110 or the second end 115 when the valve 100 is in the closed position. As shown in FIGS. 3 and 4, the vent 165 is disposed proximate the second end 115, which is shown as the outlet end in FIGS. 3 and 4. However, the vent 165 can also be disposed proximate the inlet end to allow gas or fluid inside the ball 150 to escape on the inlet side rather than the outlet side.

The vent 165 is arranged inside the ball 150 so as to allow gas or fluid to escape from the ball 150 rather than freezing and/or increasing in pressure, thereby damaging the ball 150. The ball valve 100 can therefore protect the ball 150 without a complicated structure requiring an outlet to, for example, atmosphere or a reduced pressure area. Indeed, when in the closed position, the ball valve 100 permits air or fluid to escape only from the vent 165 and into one of the first 110 or second 115 ends, and does not allow gas or fluid to escape from any other opening in the ball valve 100. As shown in FIG. 3, when the valve 100 is in the closed position, the interior structure of the pipe 105 closes the bore 160 from the first 110 and second 115 ends, such that the bore 160 can only communicate with one of the first 110 or second 115 ends via the vent 165. As such, the vent 165 provides the only means for gas or fluid to escape from the ball 150.

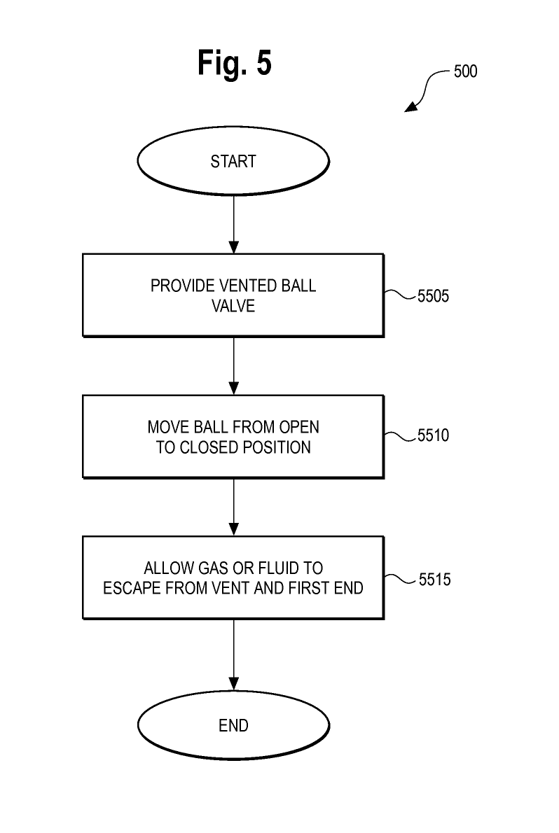

FIG. 5 is a flow chart disclosing a process 500 according to an embodiment of the present application. As shown, the process begins and proceeds to S505 where a vented ball valve is provided. The user can then move the ball from the open to closed position in S510, either by actuating the handle 125, either through a manual operation, or through any other manner of actuating the ball 150. When the ball 150 reaches the open position, gas or fluid can escape from the vent 165 and into either the first 110 or second 115 end. As discussed, gas or fluid can escape from the vent 165 through only one of the first 110 or second 115 ends, because interior structure of the pipe 105 prevents gas or fluid inside the bore 160 from escaping from the bore 160 itself. Rather, gas or fluid inside the ball 150 can only escape by traveling through the vent 165 and out of either the first 110 or second 115 ends. This structure avoids the need for a complicated third passage leading to atmosphere, and instead provides a simple solution to relieving pressure and allowing fluid to escape from the ball 150. The above structure focuses on the gas or fluid inside the ball 150 itself, rather than the valve 100 as a whole, to provide a novel solution to a longstanding problem.

As discussed above and illustrated in the figures, the ball valve 100 includes only first 110 and second 115 ends. However, the ball valve 100 can include any numbers of ends without departing from the spirit and scope of the present application. For example, the ball valve 100 could include three or four ends where multiple balls 150 are used to selectively permit the flow or gas or fluid in the valve 100.

The vent 165 is disclosed above as being a simple opening in the valve 150 that communicates with the bore 160. However, the vent 165 need not communicate with the bore 160, and instead can communicate with a different shaped opening inside the ball 150. For example, the vent 165 can communicate with a rounded or rectangular opening inside the ball 150 to allow the passage of the internal gas or fluid of the ball 150 to the first 110 or second 115 ends. Any other means of communicating gas or fluid from inside the ball 150 to one of the first 110 or second 115 ends can be implemented without departing from the spirit and scope of the present application.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of Applicants' contribution. The actual scope of the protection sought is intended to be defined in the following claims when viewed in their proper perspective based on the prior art.

What is claimed is:

1. A ball valve comprising:
a pipe having first and second ends;
a ball movably disposed within the pipe and adapted to selectively permit passage of gas or fluid through the first and second ends, the ball having a bore defined therein adapted to communicate with the first and second ends when the ball is disposed in an open position, and having a vent hole adapted to communicate with only the first end when the ball is disposed in the closed position.

2. The ball valve of claim 1, wherein the first end is an outlet end and the second end is an inlet end upstream from the outlet end.

3. The ball valve of claim 1, wherein the first end is an inlet end and the second end is an outlet end downstream from the inlet end.

4. The ball valve of claim 1, further comprising a handle adapted to actuate the ball into the open and closed positions.

5. The ball valve of claim 4, wherein the handle includes a grip.

6. The ball valve of claim 4, wherein the handle includes a stop adapted to abut an extension of the pipe when the ball is in one of the open and closed positions.

7. The ball valve of claim 1, further comprising a valve seal disposed inside the pipe and adapted to cooperate with the ball to impede the flow of the gas or fluid when the ball is disposed in the closed position.

8. The ball valve of claim 4, wherein the pipe includes an extension extending from the pipe, and wherein the handle is coupled to the extension by a fastener.

9. A method of resisting pressure buildup in a ball disposed within a ball valve, the method comprising:
providing the ball valve having a pipe with first and second ends and a ball movably disposed within the pipe, the ball having a bore defined therein adapted to communicate with the first and second ends when in an open position, and further having a vent hole adapted to communicate with only the first end when in a closed position;
moving the ball from the open position to the closed position; and
allowing gas or fluid inside the ball to escape the ball through the vent hole and through the first end, wherein interior structure of the pipe resists the gas or fluid from escaping from any opening other than the vent hole and the first end.

10. The method of claim 9, wherein the first end is an outlet end and the second end is an inlet end upstream from the outlet end.

11. The method of claim 9, wherein the first end is an inlet end and the second end is an outlet end downstream from the inlet end.

12. The method of claim 9, wherein the step of moving the ball is performed by rotating a handle adapted to actuate the ball into the open and closed positions.

13. The ball valve of claim 12, wherein the handle includes a grip.

14. The ball valve of claim 12, wherein the handle includes a stop adapted to abut an extension of the pipe when the ball is in one of the open and closed positions.

15. The ball valve of claim 9, further comprising providing a valve seal disposed inside the pipe and adapted to cooperate with the ball to impede the flow of the gas or fluid when the ball is disposed in the closed position.

16. The ball valve of claim 12, further comprising providing an extension extending from the pipe, and coupling the handle to the extension with a fastener.
